(19) United States
(12) Patent Application Publication
(10) Pub. No.: US 2017/0116874 A1
(43) Pub. Date: Apr. 27, 2017

(54) TACTICAL SKILLS DEVELOPMENT, ASSESSMENT AND REPORTING SYSTEM

(71) Applicant: TDPB HOLDINGS, LLC, Ann Arbor, MI (US)

(72) Inventors: Randolph E. HOLCOMB, Ann Arbor, MI (US); Abu-Bakr SAMORY, Bronx, NY (US); Brian R. DERICKSON, Ann Arbor, MI (US)

(21) Appl. No.: 14/923,788

(22) Filed: Oct. 27, 2015

(51) Int. Cl. G09B 9/00; A63F 13/837; A63F 13/537

(52) U.S. Cl. CPC G09B 9/003; A63F 13/537; A63F 13/837

(57) ABSTRACT

A tactical skills development, assessment and reporting system for providing a user interface at a remote user device may include a central processor in communication with a plurality of participant devices within a training field, each participant device being associated with a participant and being configured to detect impact, the user interface at the remote user device configured to: present a display screen to receive user input; and present a live feed screen indicating indicia listing at least one participant, and presenting at least one continually updated participant score for the at least one participant based on detected impact at the participant device.

### TECHNICAL FIELD

Disclosed herein are tactical skills development, assessment and reporting systems for non-lethal combat events.

### BACKGROUND

There is an emerging interest in combat simulations worldwide. Such simulations offer a network for players to showcase various events. To address such interest, a combat simulations industry is emerging. In the private and public sectors, professional marksmen, including military personnel and law enforcement agencies, use airsoft weapons, as well as real combat gear to train and simulate high-pressure situations in an effort to increase tactical response in real-combat situations. Current combat simulations fail to create a universally integrated system for skills development, scoring, analyzing and reporting combat events.

### SUMMARY

A tactical skills development, assessment and reporting system may provide a user interface at a remote user device. The system may include a central processor in communication with a plurality of participant devices within a training field. Each participant device may be associated with a participant and is configured to detect impact, the user interface at the remote user device configured to: present a display screen to receive user input; present a live feed screen indicating indicia listing at least one participant, and presenting at least one continually updated participant score for the at least one participant based on one or more detected impact at the participant device.

A method for continually updating at a central processor a user interface of a tactical skills development system may include receiving at least one impact signal indicative of an impact at a wearable device, the impact signal including an impact location, a participant location, an impact force, and a time stamp, updating event data based on the impact signal, and presenting a live feed screen indicating a participant score based on the event data.

A wearable device for a tactical skills development, assessment and reporting system, may include at least one impact sensor, a location unit, at least one controller configured to receive an impact signal from the at least one impact sensor in response to the impact sensor detecting an impact above an impact threshold at the at least one impact sensor and to generate impact data including a location, a time and a force associated with the impact based at least in part on the impact signal.

### BRIEF DESCRIPTION OF THE DRAWINGS

The embodiments of the present disclosure are pointed out with particularity in the appended claims. However, other features of the various embodiments will become more apparent and will be best understood by referring to the following detailed description in conjunction with the accompanying drawings in which:

FIG. 1 illustrates an example diagram of a tactical skills development, assessment and reporting system;

FIGS. 2A and 2B illustrate example participant devices for tactical skills development, assessment and reporting system;

FIG. 3 illustrates an example diagram of the tactical skills development, assessment and reporting system and a block diagram of the participant device for the same;

FIG. 4 illustrates an example process flow diagram for the tactical skills development, assessment and reporting system;

FIG. 5 illustrates an example process for the tactical skills development, assessment and reporting system;

FIG. 6 illustrates another example process for the tactical skills development, assessment and reporting system; and

FIGS. 7A-7K illustrate example screen shots for a user interface of the tactical skills development, assessment and reporting system.

### DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

Described herein is a tactical skills development, assessment and reporting system capable of monitoring a non-lethal combat game such as a paintball game. Each participant may wear a wearable device or apparatus to be inserted into a wearable item, such as a vest, capable of detecting impact via various sensors within the wearable device. Each recognized ‘hit’ at the wearable device may be transmitted to a central processor configured to correlate data received from the wearable device.

The central processor may then determine if, when, by whom, and to what extent a participant has been ‘hit’ by another participant. This data is then used to develop participant and event information such as hits, shots, participants and team scores, participant's status′, etc. The central processor may provide various screens to remote user devices, either in real-time, or post-event. The screen shots may convey information about the event to both participants and non-participants such as the game score, participant statistics, etc. Additionally or alternatively, the central processor may also transmit status signals back to the wearable devices indicating a status associated with that participant and/or the game mode.

The system may include wearable technology, such as a vest, that is capable of enhancing the authenticity of combat simulations by being able to accurately detect shots from airsoft weapons (e.g., paintball guns, pellet guns, etc.). Such weapons may mimic the weight and feel of M4/M16 military weapons. The wearable device may include various electronic components such as sensors, power supplies, controllers, wireless transceivers, etc. Such components include hardware components, such as an Intel® Edison board.

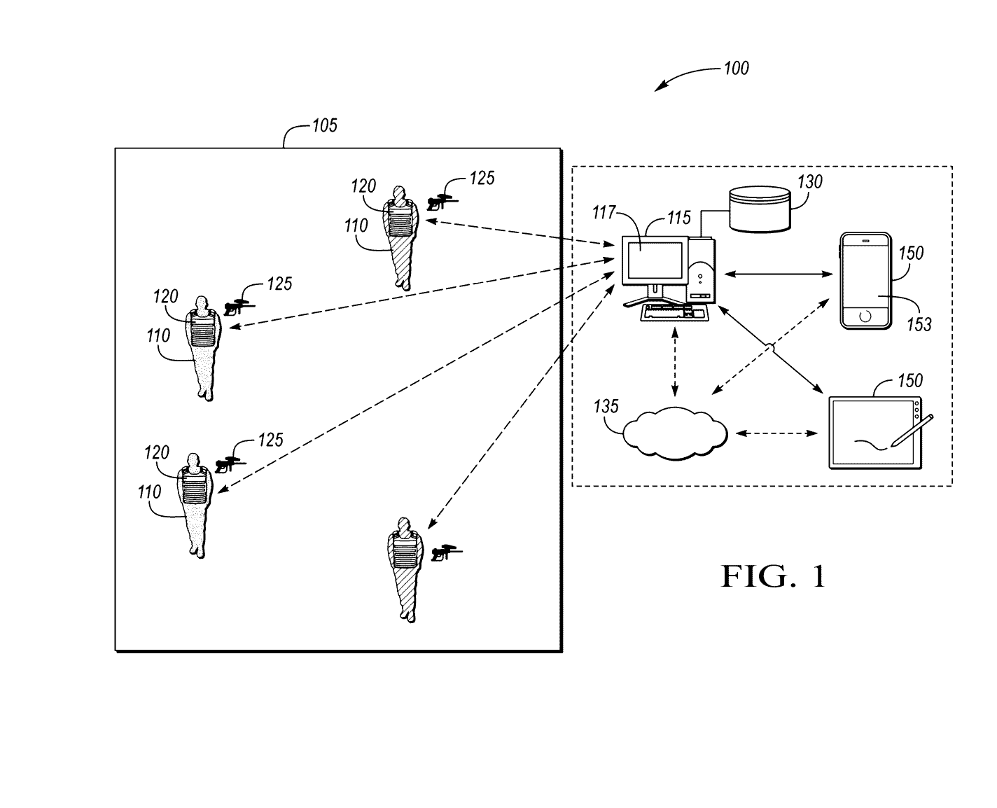

FIG. 1 illustrates an example diagram of a tactical skills development, assessment and reporting system 100 (also referred to herein as system 100). The system 100 may include a “battleground” or playing field 105 for a combat event (e.g., paintball game, laser tag game, training simulation, etc.) The playing field 105 may include an arena surrounded by various seating arrangements to permit allow spectators to view the combat event. The field 105 may also be a general playing area for participants 110. The playing field 105 may be defined by a boundary such as a wall, fence, or other barrier and may include entrance and exit points (not shown). The field 105 may include various characteristics (not shown) to simulate a combat situation such as obstacles, structures, terrain, barricades, etc.

Various participants 110, or players, may enter the field 105 to participate in the combat event. The example of FIG. 1 illustrates two teams consisting of two participants 110 each. Each participant 110 may be wearing a participant device 120 (also referred to herein as a wearable device 120) and carrying a firearm 125 (e.g., non-lethal gun). This combat event may include non-lethal impact events such as a paintball game. While the examples herein refer to a paintball game, other forms of combat events may be appreciated using the disclosed systems and methods. In one example, an event using laser technology, such as laser tag, may be implemented. Other forms of non-lethal trajectory technology may also be used. Furthermore, while the combat event may include a participant versus participant event, single participant events, such as training simulations, may also be implemented. For example, single participants may participate in training or practice scenarios wherein the participant 110 attempts to hit various targets throughout the playing field 105 with his or her firearm 125. In another example, the participant 110 may use various obstacles and barricades within the playing field 105 to avoid impact from projectiles.

Each participant device 120 may be in communication with a central processor 115. The central processor 115 may be located remotely from the participant device 120. That is, the processor 115 may not be located within the wearable device 120, though the processor 115 may be located near or next to the playing field 105. The processor 115 may also be located in another venue across the state, or even across the country. The processor 115 may be managed by an administrator, who may customize certain combat events to simulate certain combat scenarios.

The processor 115 may include a database 130 configured to maintain data including event data, participant data and identifications, wearable device locations, impact data, etc. Additionally or alternatively, the data may be maintained at a cloud server 135, or another remote server (not shown).

The database 130 may maintain certain logs and/or profiles for events, participants, teams, etc. When the central processor 115 receives the impact data from the wearable devices 120, the central processor 115 may update the logs of the affected events, participants, and teams. For example, event data may be updated to indicate that an impact was received by a first participant; that the impact was caused by a second participant; that the impact was received at a shoulder of the first participant; and that the impact was received at 05:23:45. The database 130 may also maintain user participant profiles, team profiles, standings, rankings, etc.

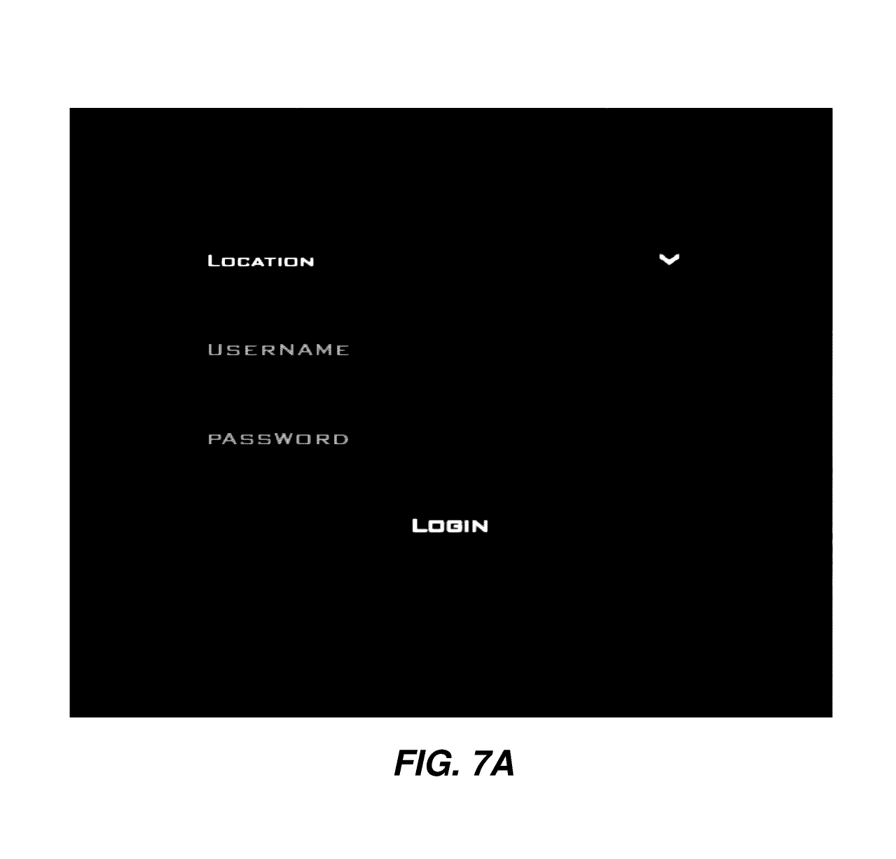

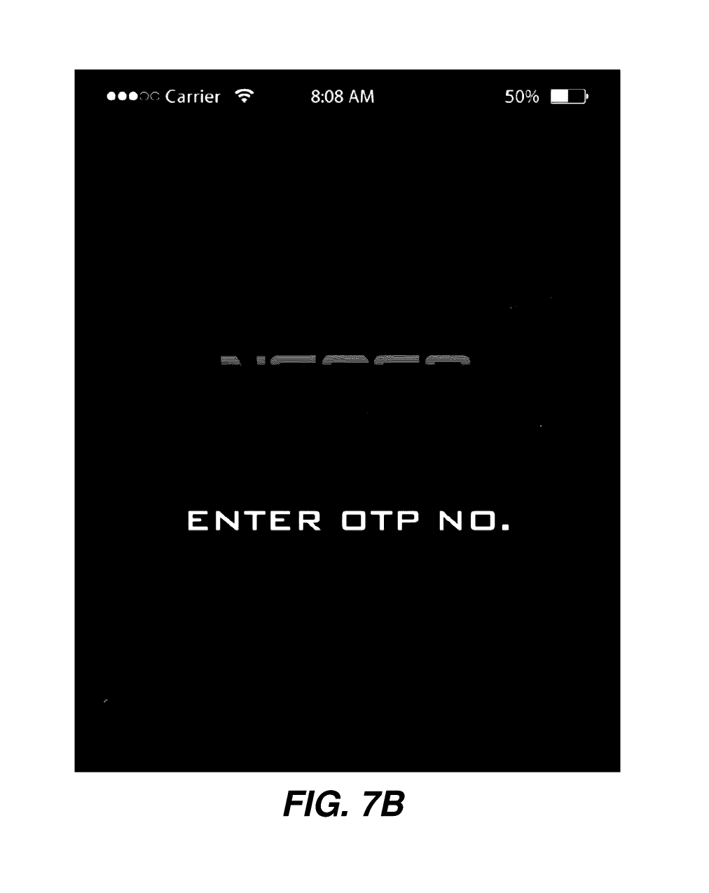

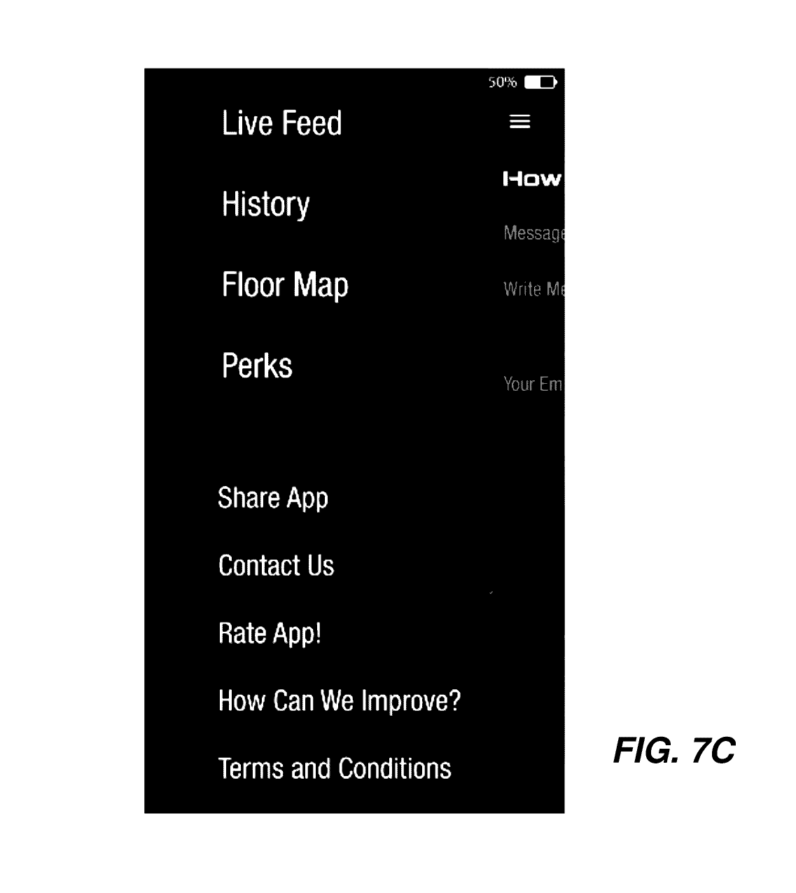

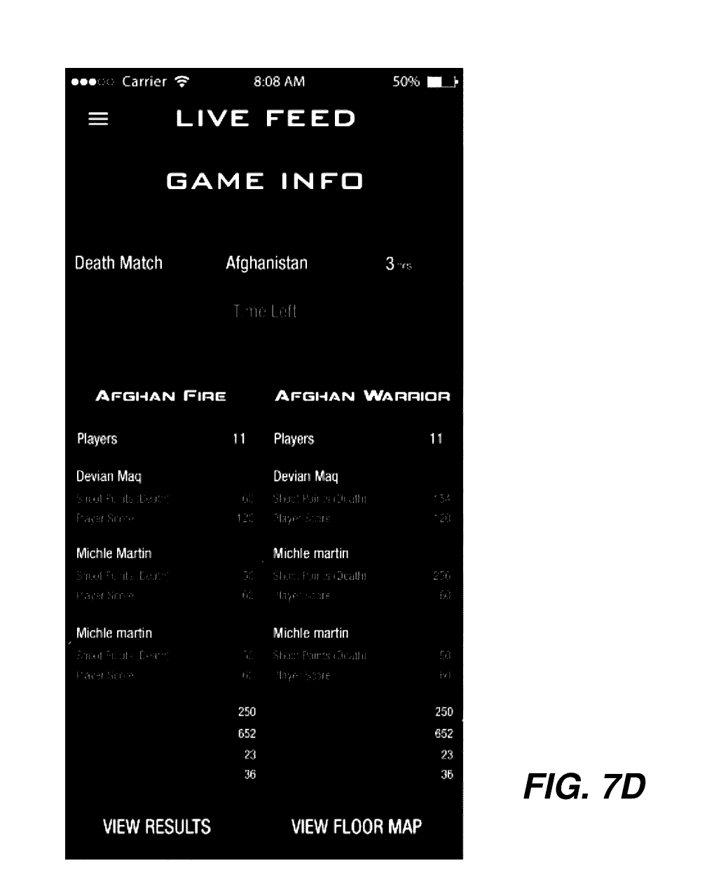

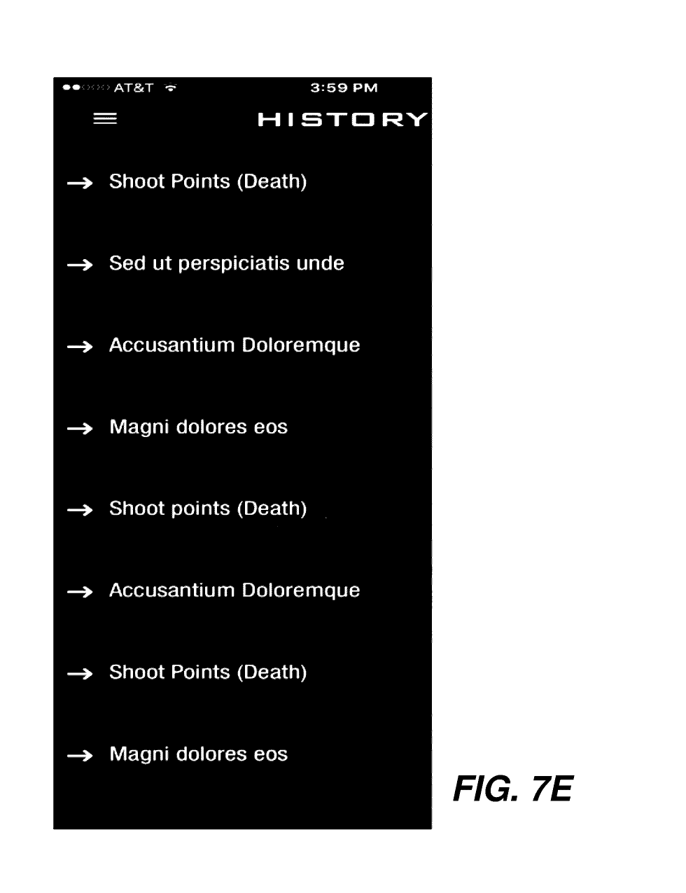

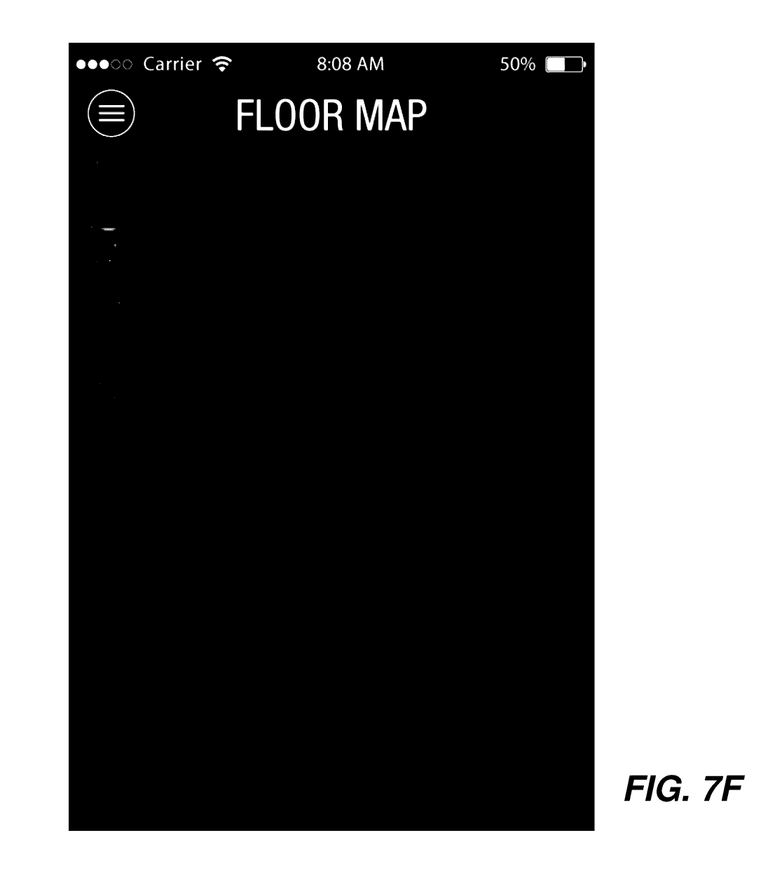

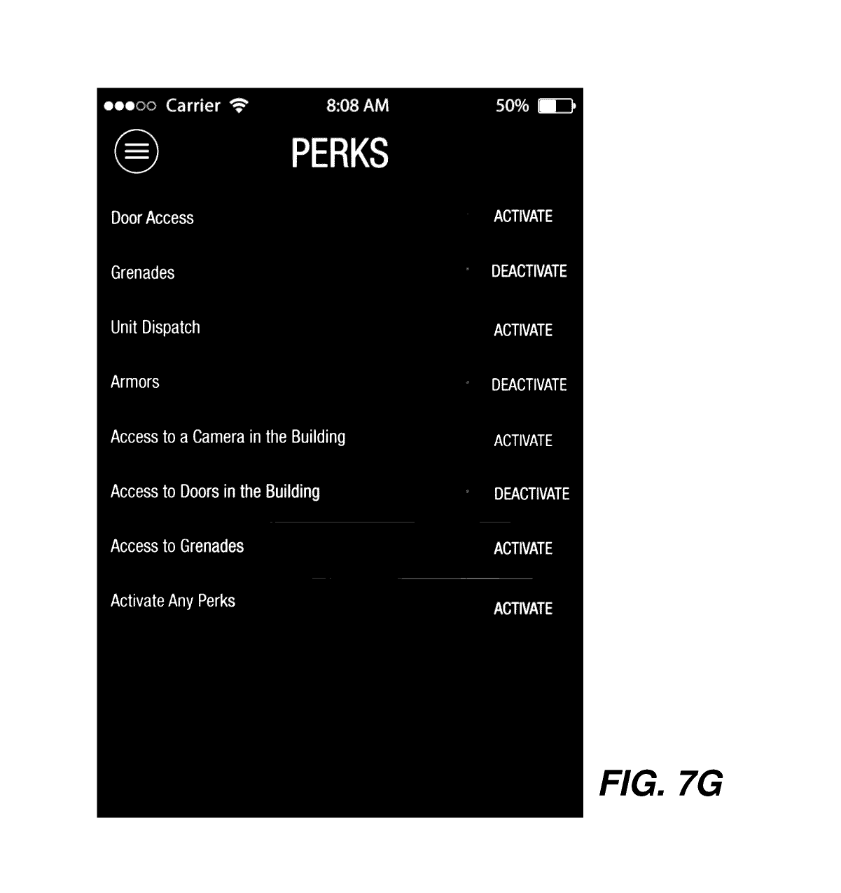

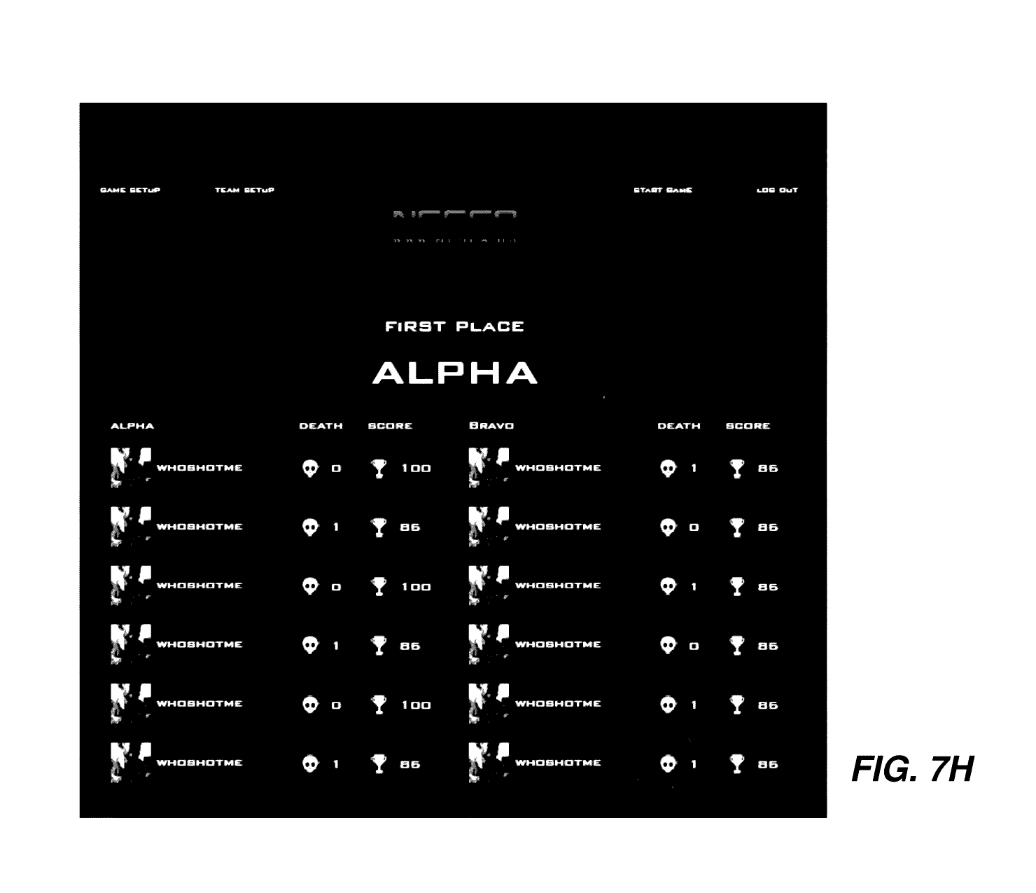

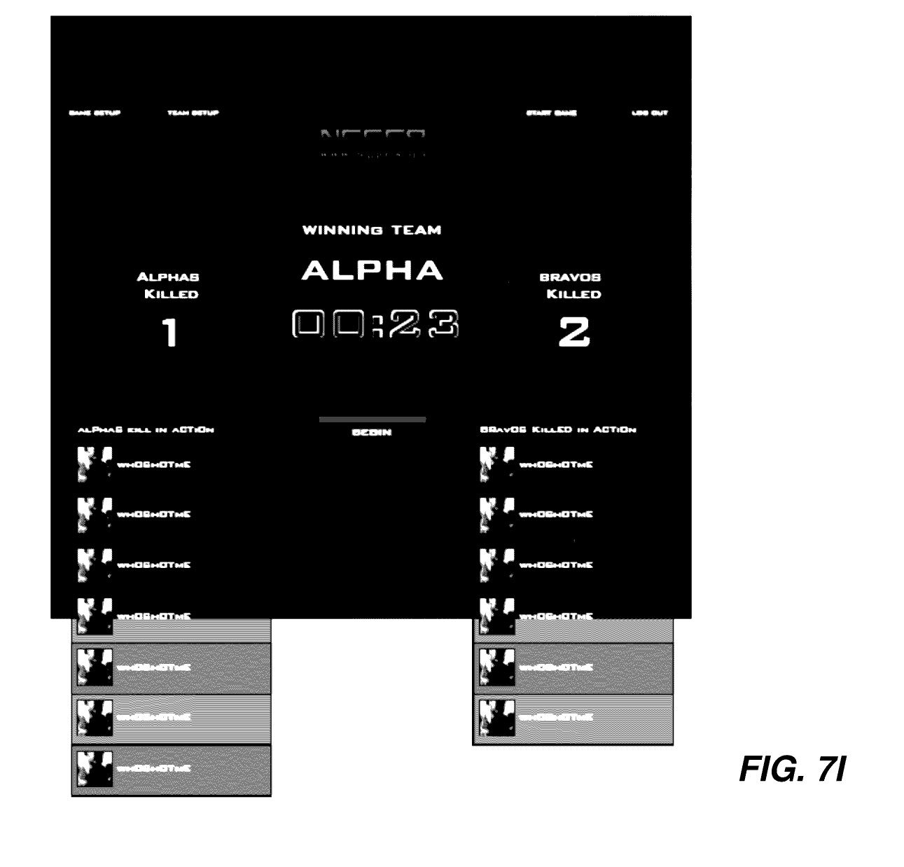

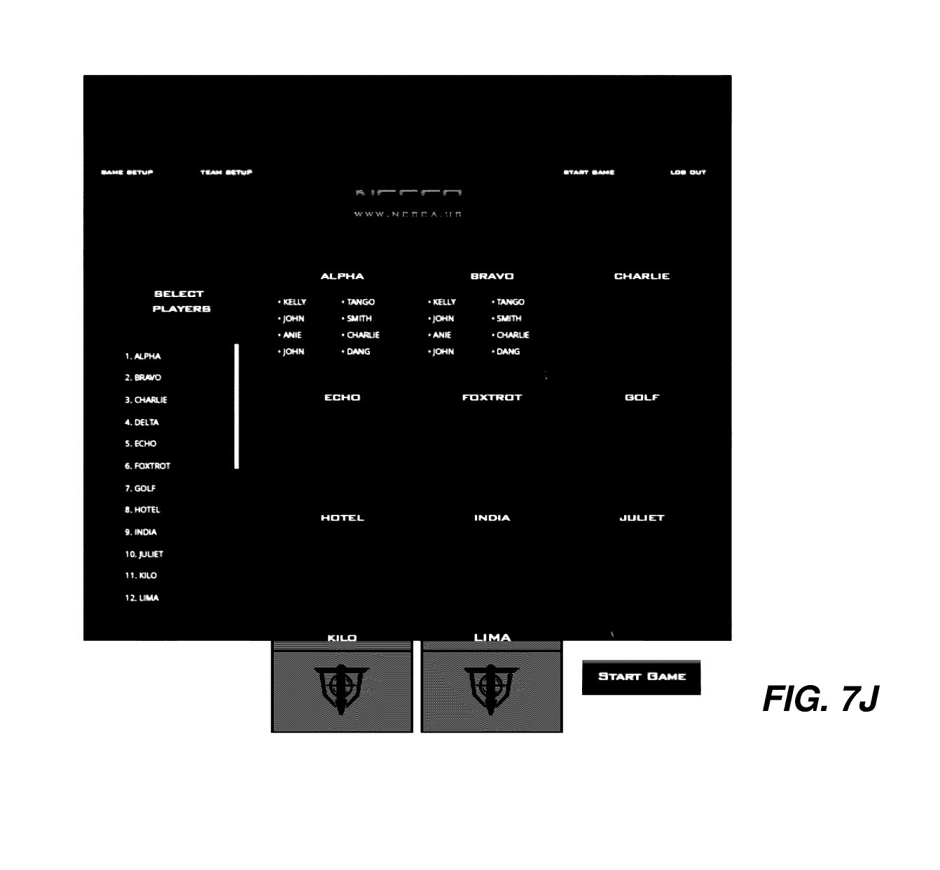

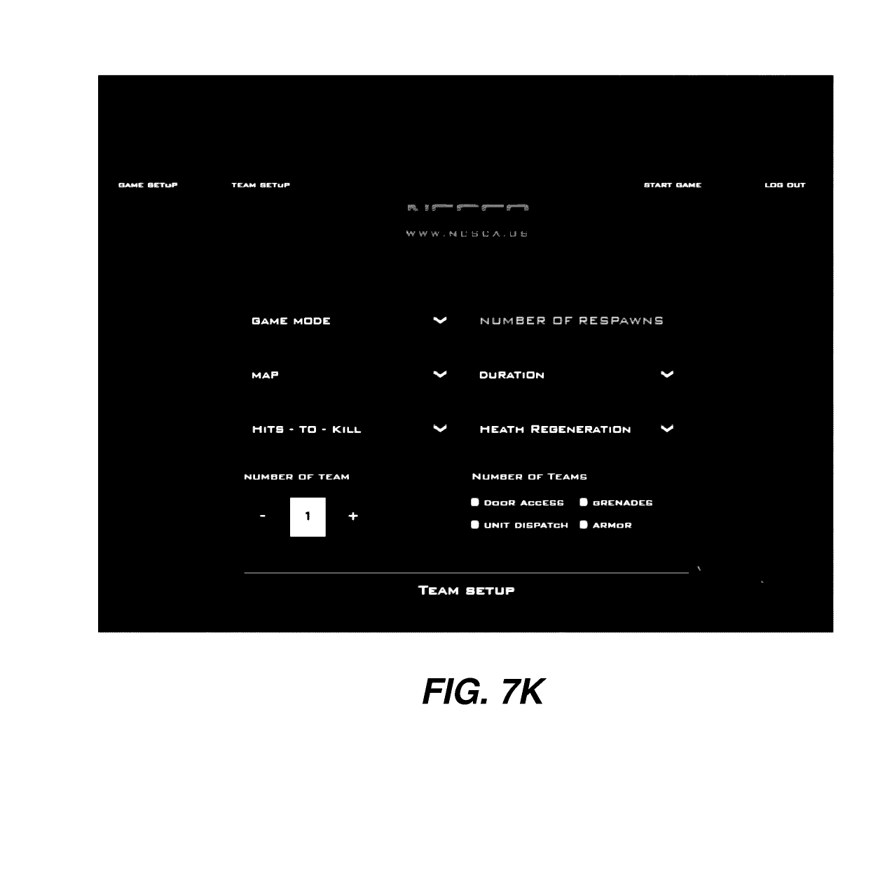

The database 130 may also maintain user credentials. These credentials may include a unique user identification number and associated password or passcode allowing the user/participant to log in via an application at a mobile device 150 to gain access to personalized statistics, real-time updates, rankings, activity reports, etc. The database 130 may also maintain various “perks” and awards associated with certain teams, participants, etc. Exemplary perks are discussed below with respect to FIG. 7G.

The processor 115 may analyze data received from the wearable devices 120 and provide various reports that may include event statistics such as participant and team scores, hit analysis, event recreation, etc. The central processor 115 may produce specialized reports, often customizable to requests received from users at the application at the mobile device 150, to rank participants' tactical abilities in comparison with other participants. These reports, often supplied via various interfaces, are described in more detail herein.

The central processor 115 may be in communication with at least one mobile device 150. The mobile device 150 may be a remote user device such as a smartphone, personal digital assistant (PDA), personal computer, tablet computer, monitor, etc. The mobile device 150 may be configured to communicate with the central processor 115 and/or the cloud server 135 to receive the data maintained therein. The mobile device 150 may maintain the application to provide various interfaces regarding the combat event in response to various user inputs. These interfaces are described in more detail below with respect to FIGS. 7A-7K.

At the central processor 115, an administrator, via a central display 117, may select various combat event options, customize the combat event (e.g., set an event time, number of players, select teams, etc.). The administrator may also create tournaments, various training scenarios, etc. The central processor 115 may maintain event data from a plurality of events. The event data may be used to establish participant rankings, team rankings, etc. That is, participants and teams may be ranked across multiple combat events. More so, the combat events may be played across various playing fields at different locations.

While the mobile devices 150 are shown as being included in the system 100 adjacent to the playing field 105, the mobile device 150 may be located remotely from the playing field 105. For example, the mobile device 150 may be located outside the playing field 105 in spectator areas, or outside of the playing field 105, including another state or country. Thus, the mobile devices 150, via the application and a mobile display 153, may receive real-time or near real-time event statistics regardless of their proximity to the playing field 105. Additionally, one or more of the participants 110 within the playing field 105 may carry a mobile device 150 and use the device 150 throughout the combat event to gain insight as to teammate and opponent locations, participant status, etc.

Each participant 110 may carry at least one firearm 125. The firearm 125 may be a non-lethal device configured to imitate a gun-like device. The firearm 125 may project an item or signal (referred to herein as projectiles) in response to a trigger being pulled. In one example, the firearm 125 may be an airsoft device paintball gun configured to project paintballs. In another example, a laser gun may emit an electronic signal. In yet another example, the firearm 125 may be a rifle or pistol compatible with force-on-force conversion kits. Other devices may also be used, including bows, sling shots, water guns, etc.

The firearm 125 may include a Bluetooth™ attachment kill switch (not shown) which is configured to attach to any standard airsoft rifle or firearm 125. The kill switch permits the central processor 115 to transmit commands to the firearm 125. Such commands may include deactivating a trigger or preventing the firearm 125 from causing impact to another participant. Other commands may include feature enhancement commands such as commands that give access to special perks and rewards during the combat event. The central processor 115 may transmit this command in response to the participant 110 being disqualified, terminated, or in response to a perk or award used by another participant that enables such deactivation. Various ‘perks’ are described below with respect to FIG. 7G. In general, feature enhancement commands, similar to the above examples, may include perks and rewards, or may affect other participant devices in a specific way. One example would be a shut down of all opponent electronics (e.g., firearms 125) within a certain radius or for a certain time frame. Other features may include delayed detonation, and opponent location detection.

In another example, the kill switch may permit a system administrator to deactivate all firearms 125 and other weapon within the arena if a person has been disqualified or in the event of an emergency.

The firearm 125 may also include a grenade device, including but not limited to a grenade launcher and respective grenades. The grenades may cause impact at the wearable device 120 similar to a paintball, or other projectile.

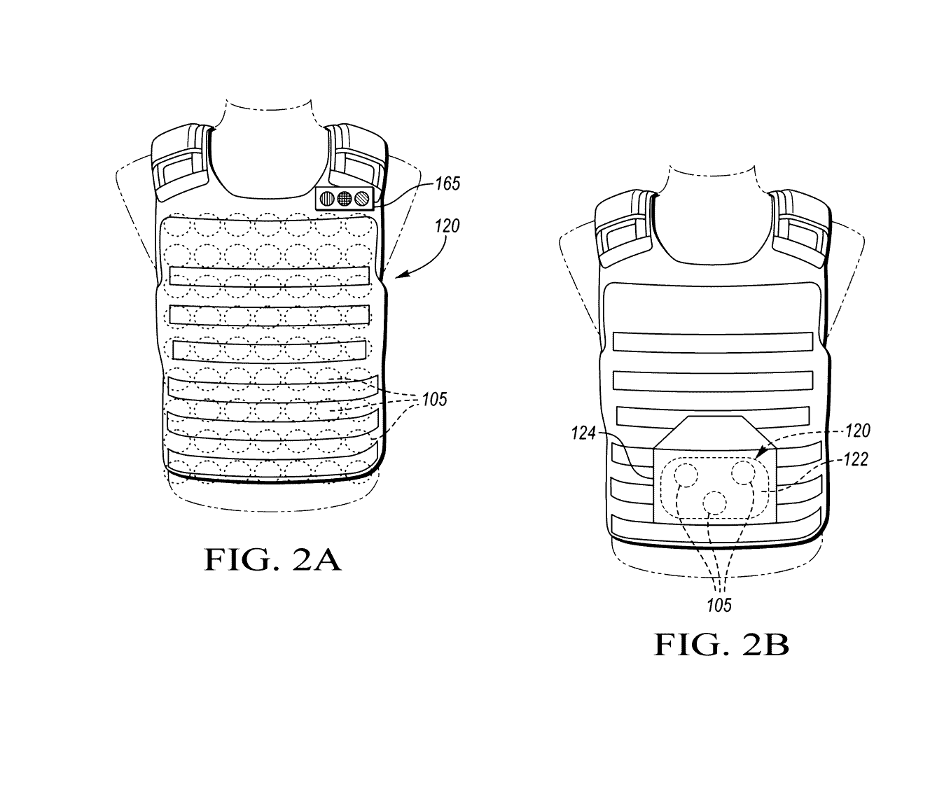

FIGS. 2A and 2B illustrates example participant devices 120. The participant device 120 may be a wearable device designed to be worn by participants 110 during the combat event, such as the example shown in FIG. 2A. In this example, the wearable device 120 may cover, at least in part, the front and the back of the participant 110, thereby covering the lungs and the heart and other vital organs. The wearable device 120, may be a vest-like device configured to cover the upper body of a participant 110. The wearable device 120 may include other apparel-like forms including t-shirts, coats, etc. The wearable device 120 may be a full-body suit covering most of the participant's body. The wearable device 120 may also include wearable apparel in addition to a vest such as a helmet and/or leg covers.

Referring to FIG. 2B, the participant device 120 may also be a plate device 122, configured to be inserted into a portion of a wearable item, such as the vest. The

The wearable device 120 may include at least one sensor 140 configured to detect impact at the wearable device 120. The sensor 140 may be a piezoelectric sensor configured to measure the force of an impact. The wearable device 120 may include a plurality of sensors in order to detect impact at various locations on the wearable device 120. The sensors 140 and plates may be sewn or fastened within the wearable device 120 so that the sensors 140 are maintained within the wearable device 120 during the combat event.

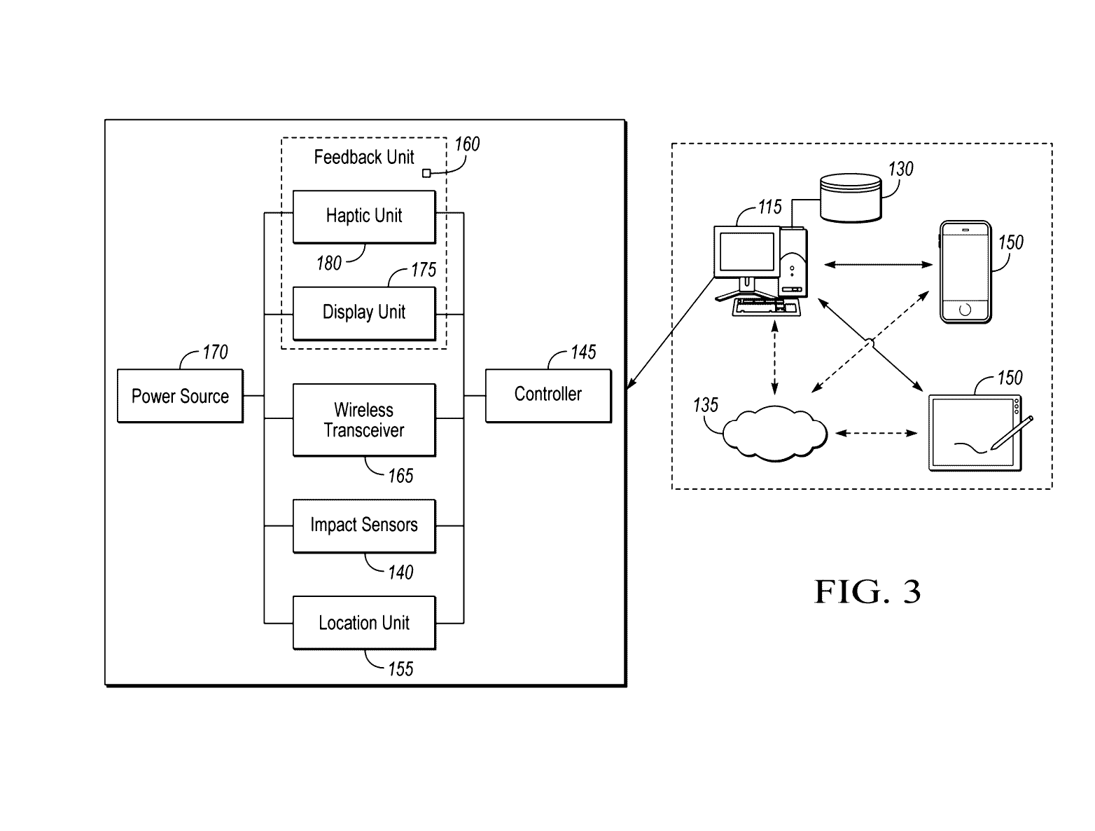

Referring to FIG. 2B, the wearable device 120 may include at least one small arm protective insert (SAPI) plate, referred to herein as plate device 122, such as a Kydex™ 10″×13″ plate, configured to maintain a plurality of sensors 140, a power source and controller (as described in more detail below with respect to FIG. 3. The plate device 122 may be insertable into a front pocket 124 of a standard-issue vest, thus providing for flexibility, interchangeability, and ease of use. Furthermore, by inserting the plate device 122 into the pocket 124, the plate may be central to various ‘kill zones’, and may capture impact indicative of terminal impacts.

Referring now to FIG. 3, the sensors 140 may be in communication with a controller 145, also arranged within the wearable device 120. The controller 145 may be a microprocessor or micro-controller such as an Intel™ Edison processor. The controller 145 may be configured to receive sensor data from the sensors 140. The sensor data may include sensor identification and a voltage that is proportional to the force received at a specific sensor 140.

The controller 145 may analyze the received sensor data to determine the proportional force of the impact received at the sensor 140. That is, when a projectile hits one of the sensors 140 within the wearable device 120, the controller 145 determines at what force the projectile hits the sensor 140. During use, the sensors 140 within the wearable device 120 may recognize various impacts, though not all impacts may be received in response to projectiles. The sensors 140 may recognize various impacts from the normal wearing of the wearable device 120. Participants 110 may bump into objects, press against barricades, etc. To discern between impacts from normal wearing of the wearable device 120 and from impacts caused by projectiles, the controller 145 may determine whether the force exceeds a predefined threshold force. Such a force may be, for example, approximately 500 Newton. Typically, an impact caused by a projectile generates a force between 600 and 1023 within a time frame of six microseconds. The controller 145 may also determine whether the impact is from a projectile by determining whether the voltage from the sensor 140 exceeds a predefined threshold voltage. The impact force may also be used to determine at what distance with respect to the wearable device 120 the projectile was sent from (i.e., how far away the shooter was from the wearable device 120.) The larger the force, the shorter the distance.

The sensor identification may indicate a location within the wearable device 120. The various sensors 140 may be arranged throughout the wearable device 120. Impact received at a specific sensor 120 may indicate the impact location (e.g., where the participant 110 was hit). The central processor 115 may use the impact location to determine a participant status. For example, if the impact location is close to a vital organ such as the heart, the central processor 115 may determine that the impact had a greater effect on the participant status (e.g., general “health”) than if the impact location is to a non-vital organ such as a leg or shoulder. The impact location may also affect the shooter score and statistics. That is, a hit to a vital organ may be awarded more points than a hit elsewhere.

The wearable device 120 may include a location unit 155 configured to determine a location of the respective participant 110. The location unit 155 may be a global positioning system (GPS) unit, or other locating device. The location unit 155 may be in communication with the controller 145 and may continually provide location data to the controller 145. Each location unit may be associated with a wearable device identification. The wearable device identification may be associated with a specific participant 110. Thus, the location unit 155 may identify the location of the specific participant 110.

The wearable device 120 may also include at least one feedback unit 160. The feedback unit 160 may provide feedback to the participant 110 indicative of a participant status, opponent status, mode of operation, etc. For example, a participant status may include a “healthy” status, an “injured” status, and a “terminated” status. The status, as determined by the controller 145, may depend on the impacts detected by the wearable device 120. For example, the controller 145 may determine that a participant is “terminated” in response to an impact or hit to a vital organ area. The controller 145, on the other hand, may determine that a participant is “injured” in response to an impact or hit to a non-vital organ area such as a shoulder. However, multiple impacts (i.e., when a number of hits exceeds an allotted number of hits) to a non-vital organ may eventually result in the participant being “terminated.” The participant status may also be restored to “healthy” after a predefined time period has lapsed.

The feedback unit 160 may also indicate a mode of operation, which may include, for example, an inactive mode, an active mode, and a de-activation mode. The inactive mode may be an inactive combat state where all firearms 125 are electronically powered off. Further, within the wearable device 120, the sensors 140 and controller 145, as well as the feedback unit 160, are also deactivated (e.g., turned off), in an effort to conserve power. The location unit 155 may generally be active at all times and may continue to transmit the location of the wearable device 120 to the central processor 115.

The active mode may be an active combat state where all of the firearms 125 are electronically powered on. The wearable device 120 and the components therein are also powered on and ready to detect hits and transmit impact data indicative of valid hits to the central processor 115.

The deactivation mode may be a deactivation state where the firearms 125 and components of the wearable devices 120 (e.g., sensors 140 and controller 145) are powered down and deactivated following the active mode.

The feedback unit 160 may include a display unit 175 and a haptic unit 180. The display, as shown by way of example in FIG. 2, may include light unit or light indicator such as green, yellow, red. These light indicators may correspond to the healthy, injured and terminated statuses, respectively. Such display unit 175 may therefore indicate to the respective participant (i.e., the wearer), as well as other participants, including team members and opponents, the status of the respective participant. Such information may be beneficial to both teammates and opponents alike, as well as the wearer.

Additionally or alternatively, the light indicators may correspond to one of the modes of operation. For example, a red light may indicate an inactive mode, a green light may indicate an active mode, and a yellow light may indicate a de-activation mode.

Returning to FIG. 3, the haptic unit 180 may include a haptic device such as one or more vibrating motors configured to impose a haptic perception to the participant 110. In one example, a vibration may indicate the participant status to the wearer. For example, a single pulse of the vibrating motors may indicate that the wearer has been hit. Multiple pulses at consistent intervals may indicate that the wearer has been injured. These pulses may continue until the wearer's health is restored (e.g., after a predefined amount of time without further hits), or until the wearer may be considered terminated. In the latter case, the vibrating motors may issue a continuous vibration indicating the terminated status. Such haptic feedback may indicate the wearer's status to the wearer without unduly distracting the wearer from the event. The wearer need not look at an external device and divert his eyes in order to appreciate his or her status.

Further, additional or alternative haptic status alerts may be used to indicate various statuses to the wearer outside of the wearer status. In one example, vibrations may increase in frequency or strength as the combat event comes to an end. That is, as an event clock approaches zero, the haptic feedback may increase in frequency and/or strength to indicate that time is nearly up. In another example, haptic feedback may be used to indicate initiation of the deactivation mode.

The wearable device 120 may include a wireless transceiver 165 (e.g., a BLUETOOTH module, a ZIGBEE transceiver, a Wi-Fi transceiver including a Broadcom 43340 802.11 a/b/g/n, Dual-band (2.4 and 5 GHz) on board antenna, an IrDA transceiver, an RFID transceiver, etc.) configured to transmit and receive wireless communications.

The wearable device 120 may include a power source 170 configured to supply power to each of the components therein. The power source 170 may include a battery or other portable power source. The battery may be rechargeable or replaceable.

The components within the wearable device 120 may be in communication with each other and at least in communication with the controller 145. The components may be connected via a 22 American wire gauge (AWG). Additionally or alternatively, the components may be connected via a wireless connection.

During use, the controller 145 is configured to temporarily store sensor data indicative of impacts at the sensors 140. Within a certain time frame, the controller 145 may determine which sensor data includes the highest impact value, or force value, within that time frame. Such a time frame may be, for example, six microseconds. The controller 145 then determines whether the sensor data including the highest impact value is a valid hit. That is, the controller 145 determines whether the force indicated by the sensor data exceed the predefined force threshold. This process ensures that the force value being evaluated is from a single sensor and that the best data is transmitted to the central processor 115.

Although not shown, the wearable device 120 may also include other sensors, including biometric and environmental sensors. Biometric sensors may include heart rate monitors, as well as other participant health monitors such as glucose monitors, pulse oximeters, etc. Environmental sensors may include carbon monoxide detectors, ambient temperature sensors, barometric pressure sensors, etc. These sensors may provide data to the controller 145 and/or the central processor 115. In some training and combat events, real-world combat scenarios may be simulated, which may include use of carbon monoxide, as well as other gasses. Further, participant reaction to certain situations may be logged by the system 100 using biometric data acquired by the biometric sensors.

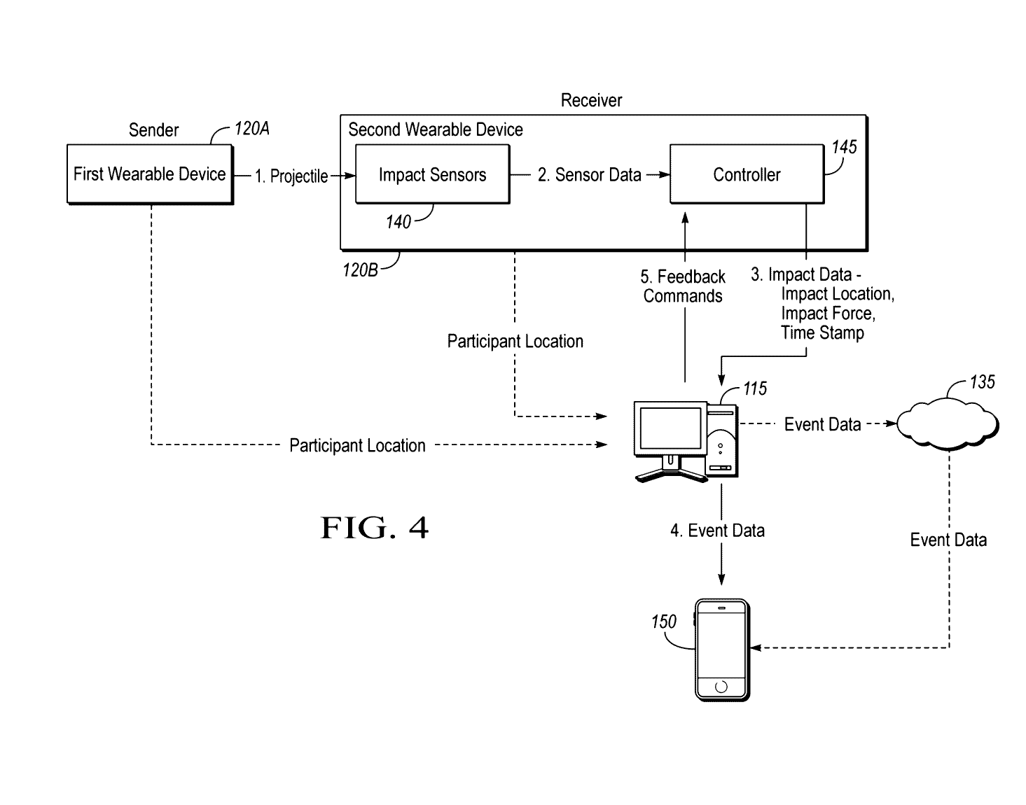

FIG. 4 illustrates an example process flow diagram for the tactical skills development, assessment and reporting system 100. FIG. 4 illustrates a first wearable device 120A and a second wearable device 120B. In this example, the first wearable device 120A is associated with a first participant (not shown in FIG. 4) who may be considered the sender (e.g., the shooter or the participant causing the impact). The second wearable device 120B is associated with a second participant (not shown in FIG. 4) and may be considered the receiver (e.g., the participant recognizing the impact).

In this example, the first participant may, via the respective firearm 125 (not shown in FIG. 4), transmit a projectile such as a paintball or pellet. The projectile may hit the second wearable device 120B at T least one impact sensor 140. The sensor 140 may recognize the hit and transmit sensor data indicative of the impact to the controller 145 of the second wearable device 120B. The controller 145 may analyze the sensor data, determine which sensor data within a time frame (e.g. six microseconds) represents the highest impact, and then determine whether the sensor data with the highest impact indicates a force above a predefined force threshold (e.g., is the sensor data indicative of a valid hit). If the sensor data is indicative of a valid hit, the controller 145 transmits impact data indicative of the hit to the central processor 115. The impact data may include at least one of an impact location, impact force and time stamp.

As shown in FIG. 4, each of the wearable devices 120A, 120B may continually transmit a participant location to the central processor 115. This allows the processor 115 to track each participant 110 at all times, regardless of the mode of operation. Participant locations may also be transmitted as part of the impact data.

Once the central processor 115 receives the impact data, the central processor 115 analyses the data, including but not limited to updating player profiles and statuses (e.g., injured, terminated, healthy), updating participant and team scores, transmitting updates and alerts to the mobile devices 150 to provide notification of the hit, log player biometric data, log environmental data, etc. By updating the database 130 or cloud server 135, the application accessible via the mobile devices 150 may also be updated so that the interfaces thereof may be continually updated in real-time or near real-time in response to action at the combat event.

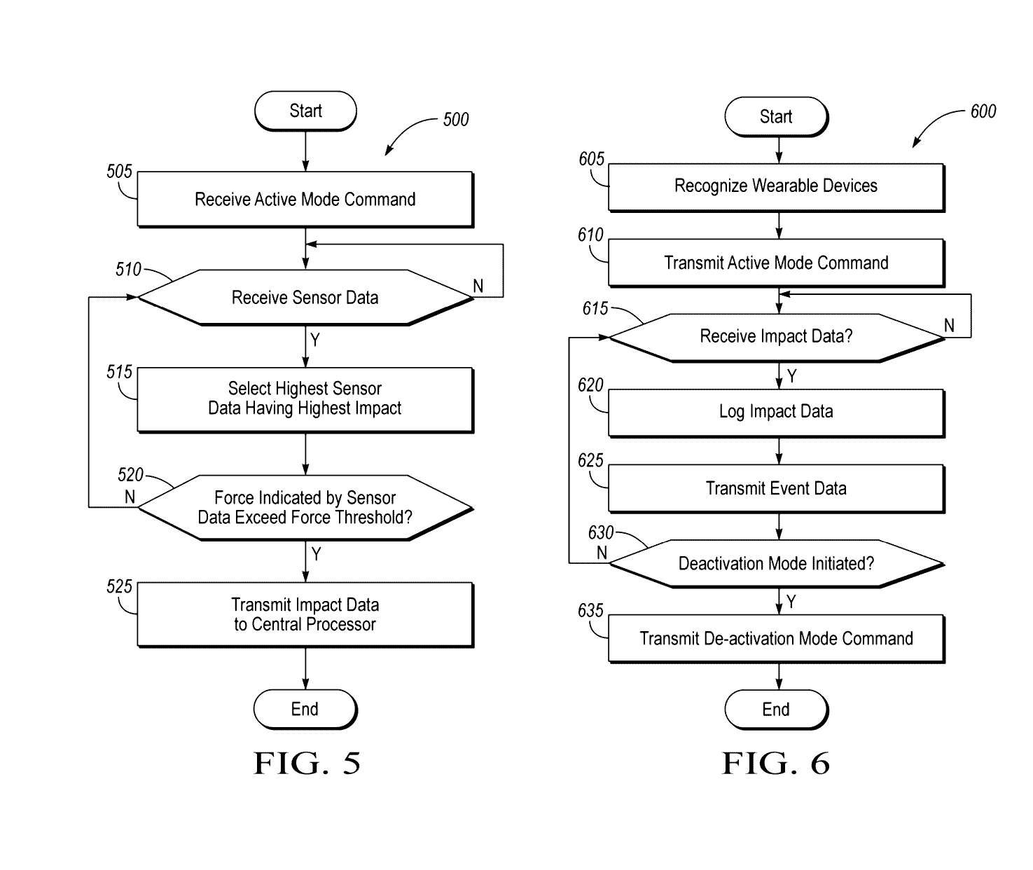

FIG. 5 illustrates an example process 500 for the tactical skills development, assessment and reporting system. The process begins at block 505 where the controller 145 within the wearable device 120 receives a command from the central processor 115 to enter into the active mode. The active mode may enable all firearms 125 and initiate the combat event. Once the combat event is initiated, the controller 145 may wait to receive sensor data from the sensors 140 at block 510.

At block 515, once sensor data is received, the controller 145 may determine the sensor data indicating the highest impact within a time frame.

At block 520, the controller 145 may determine whether the force indicated by the sensor data exceeds the force threshold. That is, does the sensor data represent a valid hit, as opposed to impact received in response to normal wear of the wearable device 120. If the controller 145 determines that the sensor data represents a valid hit, the process 500 proceeds to block 525. If not, the process 500 proceeds back to block 510.

At block 525, the controller 145 transmits the impact data to the central processor 115. Additionally or alternatively, the impact data may be transmitted to the server 135. The process then ends.

FIG. 6 illustrates another example process 600 for the tactical skills development, assessment and reporting system 100. The process 600 begins at block 605 where the central processor 115 initiates the event by recognizing the wearable device 120 within the playing field 105. As explained, each wearable device 120 may have a unique device identification and a participant associated with it. In recognizing the wearable devices 120, the central processor 115 may also recognize various teams created by one or more of the wearable devices 115. These teams may be pre-loaded, determined based on the wearable device locations, or may be administrator defined.

At block 610, once the central processor 115 has recognized the wearable devices 120, the processor 115 may transmit an active mode command instructing the wearable devices 120 to enter into the active mode.

At block 615, the central processor 115 may wait to receive impact data from the wearable devices 120. As explained, the processor 115 will receive impact data from the wearable device 120 for valid hits, as determined by the controller 145 of the wearable device 120.

At block 620, the central processor 115 may analyze the received impact data and generate event data based on the impact data. The processor 115 may determine, based on the impact data, the location of the impact on the wearable device 120, the force of the impact, as well as the participant 110 responsible for the impact (e.g., the sender). The processor 115 may determine and update a participant status in response to the impact (e.g., injured, terminated, etc.). The processor 115 may also award points or give credit to the sender for a successful hit. In turn, team scores may be updated. Although not shown in FIG. 6, feedback commands may be returned to the wearable devices 120 in response to the event data.

At block 625, the processor 115 may transmit, store, or update event data based on the analysis of the impact data. The event data may be transmitted to the cloud server 135 and/or stored in the database 130.

At block 630, the processor 115 may determine whether the deactivation mode is to be initiated. This may be in response to an event timer expiring. If the event timer expires, the process 600 proceeds to block 635, where the central processor 115 transmits a deactivation command to the wearable devices 120. The process then ends.

FIGS. 7A-7K illustrate example screen shots for a user interface of the tactical skills development, assessment and reporting system 100. The example screen shots may include interfaces as part of an administrative set-up at the central processor 115. Additionally or alternatively, the screen shots may include interfaces as displayed at the mobile device 150 as part of the user and/or participant experience. In some examples, the user may be a participant 110 within the playing field 105. In other examples, the user may be an observer, competitor, or other interested party.

FIG. 7A illustrates a log-in screen configured to receive user input in an effort to authenticate the user. The log in screen may be applicable to both an administrator and a user. That is, an administrator may log-in at the central processor 115, or other device (including devices similar to the mobile device), and a user may log in via a similar interface at their mobile device 150.

FIG. 7B illustrates an example operation number screen where the user may enter a number associated with a certain operation, training scenario, etc.

FIG. 7C illustrates an example home screen where various menu items may be provided. Upon selection, the respective screen shot may be presented via the display 117 or display 153.

FIG. 7D, for example, illustrates an example life feed screen showing game information such as a scenario mode, scenario location or map, and scenario duration. While the term “game” may be used throughout the screen shots, various training scenarios, test fields, etc., may be implemented and the term “game” is not intended to be limiting. The live feed screen may also display participant or play scores, team scores, remaining time, etc.

FIG. 7E illustrates a history screen indicative of various ‘hits’ or impacts received at the various participant devices 120. As explained, various points may be awarded in response to detected hits.

FIG. 7F illustrates an example floor map screen. The floor map screen may be continually updated based on at least one of user input and/or user location. For example, a user may open the floor map and scroll through the map to view various areas of the playing field 105. The floor map may also show the current location of the user based on information from the location unit 155. While shown as a three-dimensional image, the floor map may also include bird's eye views, top views, etc.

FIG. 7G illustrates an example perks screen. As explained above, perks may be implemented via Bluetooth™ enabled devices such as kill switches. Further, the perks may be implemented via commands received and transmitted at the central processor 115. FIG. 7G lists example perks. For example, a door access perk may indicate that various doors may be unlocked or locked.

Grenades may be another perk available to participants 110. As explained above, the grenades may describe different affects or settings that may be used during the scenario. In one example, an EMP grenade may kill all electronics for a short period of time for the opposing team. Thus, the opposing team would not have the advantage of using their mobile devices 150 for that time. In another example, a Frag grenade may kill all components, including devices 120, firearms 125, etc., for a certain radius. Further, a Stun grenade may ‘stun’ for a 10 second loss of functionality including loss of communication, firearm unresponsiveness, etc. A Semtex grenade may allow for placement of an undetectable bomb that may be triggered from a set distance. A Proximity grenade may permit opponent visibility on a radar (e.g., on the mobile device 150), for a certain radius.

Unit dispatch is a perk that may allow a participant to call for help from a tactical unit (e.g., team mates or other participants). The unit dispatch perk may transmit the requesting participant's location so he or she may be ‘saved’ or rescued from an enemy attack.

Armors may be activated or deactivated. When activated, certain impacts received at the respective wearable device 120 may be ignored.

Access to cameras to see where opponents or teammates may be located may also be available. Furthermore, access to doors within the building, including potential escape routes, may be available. The grenade features may be turned off, as well as all perks.

The perks screen may indicate which perks are activated and which are disabled. This screen may be presented on a user-specific basis. That is, the perks may be special to a specific user; while one user may enjoy some perks, others may enjoy different perks.

Thus, the mobile device 150 may be an important tool for participants 110 during the scenario.

FIG. 7H illustrates an example team placement screen showing the first place team, as well as listing various participants 110, and their respective scores within the teams. Although two teams are shown, multiple teams may be competing and ranked for a single scenario.

FIG. 7I illustrates an example administrator scenario screen showing the winning team, the amount of ‘kills’ or terminations, the participants 110 terminated during the scenario, time remaining, etc.

FIG. 7J illustrates an example administrative team set up screen. In this screen, an administrator may build teams by selecting participants from a listing of participants. Furthermore, the administrator may switch to a game set up screen, start the game, etc.

FIG. 7K illustrates an example administrative game set up screen. In this screen, an administrator may select various scenario settings such as the mode, location, duration, hits-to kill, heath limits, perk enablement, number of teams, etc.

Computing devices, such as central processor, controller, mobile device, etc., generally include computer-executable instructions, where the instructions may be executable by one or more computing devices such as those listed above. Computer-executable instructions may be compiled or interpreted from computer programs created using a variety of programming languages and/or technologies, including, without limitation, and either alone or in combination, Java™, C, C++, Visual Basic, Java Script, Perl, etc. In general, a processor (e.g., a microprocessor) receives instructions, e.g., from a memory, a computer-readable medium, etc., and executes these instructions, thereby performing one or more processes, including one or more of the processes described herein. Such instructions and other data may be stored and transmitted using a variety of computer-readable media.

Databases, data repositories or other data stores described herein may include various kinds of mechanisms for storing, accessing, and retrieving various kinds of data, including a hierarchical database, a set of files in a file system, an application database in a proprietary format, a relational database management system (RDBMS), etc. Each such data store is generally included within a computing device employing a computer operating system such as one of those mentioned above, and are accessed via a network and any one or more of a variety of manners. A file system may be accessible for a computer operating system, and make the files stored in various formats. An RDBMS generally employs the Structure Query Language (SQL) in addition to language for creating, storing, editing, and executing stored procedures, such as PL/SQL language mentioned above.

In some examples, system elements may be implemented as computer-readable instructions (e.g., software) on one or more computing devices (e.g., servers, personal computers, etc.) stored on computer readable media associated there with (e.g., disks, memories, etc.). A computer program product may comprise such instructions stored in computer readable media for carrying out the functions described herein.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. A tactical skills development, assessment and reporting system for providing a user interface at a remote user device, comprising:
a central processor in communication with at least one participant device within a training field, each participant device being associated with a participant and being configured to detect impact;
the user interface at the remote user device configured to:
present a display screen to receive user input; and
present a live feed screen indicating indicia listing at least one participant, and presenting at least one continually updated participant score for the at least one participant based on detected impact at the participant device.

2. The system of claim 1, wherein the live feed screen further indicates at least one team score continually updated based on detected impact.

3. The system of claim 1, wherein the central processor is remote from the participant devices within the training field.

4. The system of claim 1, wherein the participant device is a wearable device and includes at least one participant controller configured determine whether the impact exceeds an impact threshold.

5. The system of claim 1, wherein the central processor is configured to receive impact data from each participant device indicative of the impact, the impact data including at least one of an impact location, a participant location, an impact force, and a time stamp.

6. The system of claim 5, wherein the central processor is configured to determine the at least one participant score based at least in part on the impact data.

7. The system of claim 5, wherein the central processor is configured to transmit a participant status signal to an associated participant device, the participant status based on at least one impact at the associated participant device.

8. The system of claim 5, wherein the central processor is configured to determining which participant caused the impact at the participant device based at least in part on the impact data.

9. The system of claim 8, wherein the central processor is configured to transmit a participant status signal to an associated wearable device, the participant status signal based on which of the participants caused the impact at the wearable device.

10. A method for continually updating at a central processor a user interface of a tactical skills system, comprising:
receiving at least one impact signal indicative of an impact at a wearable device, the impact signal including an impact location, a participant location, an impact force, and a time stamp;
updating event data based on the impact signal; and
presenting a live feed screen indicating a participant score based on the event data.

11. The method of claim 10, further comprising receiving a participant location associated with each of a plurality of participants.

12. The method of claim 11, further comprising determining which of a plurality of participants caused the impact at the wearable device based at least in part on the received participant location.

13. The method of claim 10, further comprising updating a team score for at least two teams based on a summation of participant scores; and
presenting the team score within the score screen indicating the team score.

14. A device for inserting into a wearable item for a tactical skills development, assessment and reporting system, comprising:
at least one impact sensor;
a location unit; and
at least one controller configured to receive an impact signal from the at least one impact sensor in response to the impact sensor detecting an impact above an impact threshold at the at least one impact sensor and to generate impact data including a location, a time and a force associated with the impact based at least in part on the impact signal.

15. The device of claim 14, further comprising a wireless transceiver configured to transmit the impact data to a central processor remote from the wearable device.

16. The device of claim 15, further comprising at least one feedback unit configured to indicate a status of the wearable device.

17. The device of claim 16, wherein the controller is further configured to determine the status based at least in part on the impact detected at the impact sensor.

18. The device of claim 16, wherein the at least one feedback unit includes at least one light unit for visually indicating the status, the light unit including each of a red, yellow and green light.

19. The device of claim 16, wherein the at least one feedback unit includes at least one haptic device for haptically indicating the status.

20. The device of claim 14, wherein the location unit is a global position system (GPS) unit.
